(19) United States
(12) Patent Application Publication
(10) Pub. No.: US 2010/0156353 A1
(43) Pub. Date: Jun. 24, 2010

(54) LITHIUM NANOPARTICLE COMPOSITIONS FOR USE IN ELECTROCHEMICAL APPLICATIONS

(75) Inventors: Subramanian Iyer, Yorba Linda, CA (US); R. Douglas Carpenter, Tustin, CA (US); Kimberly McGrath, Newport Beach, CA (US)

Correspondence Address: KNOBBE MARTENS OLSON & BEAR LLP, 2040 MAIN STREET, FOURTEENTH FLOOR, IRVINE, CA, 92614, US

(73) Assignee: QUANTUMSPHERE, INC., Santa Ana, CA (US)

(21) Appl. No.: 12/338,997

(22) Filed: Dec. 18, 2008

(51) Int. Cl. H02J 7/00; H01M 4/40; B05D 5/12

(52) U.S. Cl. 320/137; 252/182.1; 429/231.95; 428/403; 427/77; 427/78; 977/773

(57) ABSTRACT

Nanoscale lithium compositions are disclosed which are suitable for use in electrochemical applications such as electrodes and batteries. The compositions can include nanoparticles having lithium metal and/or lithium alloy cores. A shell material is contemplated comprising lithium nitride or another material that conducts lithium ions. Methods of preparing lithium compositions and methods of preparing electrodes comprising lithium compositions are further disclosed. The crystal structure of the nanoscale lithium compositions is preferably body centered cubic, allowing low volume expansion and high diffusivity of lithium from or into the core structures during discharge and charge processes, respectively.

### BACKGROUND

1. Technical Field

This disclosure generally relates to materials and methods of making materials for electrochemical applications, and more specifically, for battery electrodes.

2. Related Art

Lithium metal has many valuable characteristics as an electrode material in energy storage devices. It has low electro negativity (0.98 Pauling units) and therefore can readily give up a single electron in an electrochemical reaction. Additionally, Li is one of the lightest elements on the periodic table and therefore does not contribute a significant amount of weight relative to its energy. With a theoretical specific capacity of 3856.6 mAh/g, Li is a good candidate for the anode electrode in a rechargeable Li-ion battery, especially when paired with a high voltage cathode material, such as lithium cobalt oxide.

Unfortunately, due to battery safety concerns, the use of a pure Li metal anode is limited. For example, the high reactivity of Li can lead to electrolyte degradation and/or an increase in battery temperature that can lead to a thermal runaway reaction, potentially resulting in damage or destruction of the battery and any operating device drawing power from the battery. Similarly, using metallic Li as the anode can lead to dendrite formation over repeated charge-discharge cycles, causing a cell short, with attendant safety issues.

Battery safety concerns have been ameliorated to some extent by development of Li alloy anodes. Li alloys are often formed by alloying Li with at least one less reactive metal or semi-metal, such as Al, Sn, or Si.

Despite their efficacy in improving battery safety, Li alloy anodes are characterized by a number of significant disadvantages. One disadvantage is that alloying reduces the activity of lithium, which consequently reduces the cell voltage. Another disadvantage is that the presence of additional elements that do not participate in the electrochemical reactions adds undesired weight and volume. Thus, the maximum theoretical energy density is reduced as compared to the level attainable with pure lithium.

Another significant disadvantage of many Li alloy anodes is their physical degradation over time caused by changes in crystal structure and specific volume on charging and discharging. This leads to capacity loss and macroscopic dimensional problems within the cell structure. Tin dioxide is an example of a metal used in Li alloy anodes. This material achieves reversible capacity by the formation and decomposition of a series of tin-lithium alloys. When a tin oxide thin film is cycled versus a lithium anode, the oxide is reduced by lithium to elemental tin and lithium oxide in an irreversible reaction. Subsequently, this metallic tin can reversibly transform into several tin-lithium alloys according to the reaction: mSn+nLi→LiₙSnₘ (e.g., LiSn, Li₅Sn₂, Li₇Sn₂, Li₇Sn₃, Li₁₃Sn₅, or Li₂₂Sn₅). The example lithium-tin system exhibits six different phases, each with different crystal structures. Investigation of the kinetics of lithium diffusion, as well as potential-composition plateaus, shows five separate constant potential plateaus. The chemical diffusion coefficient for the various phases was found to be different, with the highest coefficient in the Li₂₂Sn₅ phase. Voltages, versus lithium, for the various Li—Sn compositions, ranged from 0.380 to 0.660 volt, leading to discharge curves which were not flat. In addition, lithium insertion and extraction rates varied significantly.

It has been suggested that Li—Mg and Li—Ca alloys can be used to improve the physical degradation problem seen in many Li alloy anodes. Alloying of Li and Mg has been shown not to exert mechanical stress on the lattice, therefore enhancing overall structural stability and battery life. See, e.g., Z. Shi., M. Liu, D. Naik, and J. Gole, “Electrochemical Properties of Li—Mg Alloy Electrodes for Lithium Batteries,” J. Power Sources, 92, 70-80 (2001). Additionally, electrochemical uptake of Li ions into a Mg—C composite has also been evaluated and shown to have improved capacity and stability. See C.-M. Park, Y.-U. Kim, H. Kim, and H.-J. Sohn, “Enhancement of the Rate Capability and Cyclability of an Mg—C Composite Electrode for Li Secondary Batteries,” J. Power Sources, 158, 1451-1455 (2006). However, these alloys are prepared by chemical vapor deposition (CVD), which deposits a thin, solid metallic layer on the substrate surface. This smooth surface is prone to form Li dendrites upon cycling, increasing safety risks.

It has also been suggested that addition of Li metal particles into a host material comprising metals, metal oxides, or metal nitrides may improve battery capacity and safety. See U.S. Pat. No. 7,276,314 to Gao et al. However, the lithium particles employed were at about the 20 micron scale. At this scale, there is decreased likelihood of morphological uniformity between the lithium particles and host which may potentially limit lithium diffusion, decrease the likelihood of uniform phases between the lithium particles and the host, as well as result in non-uniform distribution of additives and binders resulting in a non-uniform electrode with increased domains of resistance. Furthermore, the method of using a lithium metal particle dispersion absorbed into a host matrix places a significant limitation on the amount of lithium that may be alloyed or intercalated into the host matrix, placing a limitation on electrode capacity.

A need remains for high voltage, stable Li electrodes with rapid recharge kinetics for use in electrochemical applications.

### SUMMARY

The present invention is a composition comprising nanoscale lithium alloy particles having improved stability for use as electrodes in rechargeable batteries, for example, lithium-ion batteries. In accordance with the invention, the nanoscale lithium alloy has a Body Centered Cubic (BCC) crystal structure to minimize phase expansion during discharge and recharge in a battery. Furthermore, the lithium alloy nanoparticle may have a core-shell structure, wherein the core is lithium metal alloy and the shell is a lithium-ion conducting material, such as lithium nitride.

Using the prepared nanoscale lithium alloys, a battery electrode may be formed by dispersing the nanoparticles in a binder and solvent to form an ink, depositing a thin film of the ink on a current collector, and heating to remove excess solvent to form a dry film. Preferably, the electrode is useful as a high capacity electrode in a lithium ion-battery, and most preferably the anode electrode.

The present invention also includes a method of preparing nanoscale lithium alloy particles. These particles are formed by bringing together Li and one or more other metals or semi-metals to form an alloy, vaporizing the alloy to form an alloy vapor, and directing a cooling gas over the alloy vapor to form nano-metal particles having a substantially uniform nanoscale particle size. The cooling gas may be an inert gas such as argon. The use of argon will result in a nanoparticle that has a metallic outer surface. Optionally, the cooling gas may be a reactive gas such as nitrogen, which can form a stable nitride shell on the surface of the lithium alloy nanoparticle.

In various embodiments, methods of preparing nanoscale body-centered cubic lithium alloy for use in an electrochemical application are provided. The methods can comprise bringing together lithium and a metallic or semi-metallic alloying material to form an alloy. The methods can comprise vaporizing the alloy to form an alloy vapor. The methods can comprise directing a cooling gas over the alloy vapor to form nanoscale alloy particles having a substantially uniform particle size, the alloy nanoscale particles being configured so as to maintain a substantially body centered cubic crystal structure during insertion and removal of lithium from the alloy during an electrochemical process. The cooling gas can comprise nitrogen gas. The methods can comprise collecting the nanoparticles in a medium that is inert to the nanoscale alloy particles. The inert medium can comprise a gas medium comprising argon or helium. The inert medium can comprise comprises a liquid medium comprising one or more of carbonates, glymes, or ionic liquids.

The above nanoscale particles can comprise a core-shell structure comprising a lithium metal or lithium alloy core and an insulating shell configured to conduct lithium ions to and from the core. The shell can comprise lithium nitride.

In various embodiments, methods of preparing electrodes using the nanoscale particles generated from the above-described methods are provided. A method of preparing an electrode can comprise dispersing the nanoscale alloy particles in a medium to form a liquid ink. The method can comprise depositing a layer of the ink onto a current collector. Depositing can comprise tape casting, draw-down, spraying, or screen-printing. The methods can comprise evaporating liquids from the ink to form a dry film.

The above-describe medium can comprise an inert liquid comprising one or more of carbonates, glymes, or ionic liquids. The medium can comprise a binding agent. The binding agent can comprise polyvinylidene fluoride or poly tetrafluoroethylene. The medium can comprise a polar solvent. The polar solvent can comprise diethyl acetamide, N-methyl pyrrolidone, or dimethylsulfoxide, hexamethyl phosphoramide. The medium can comprise one or more stability-enhancing additives or conductivity-enhancing additives. The medium can comprise one or more lithium salts. Suitable lithium salts can include lithium hexafluorophosphate, lithium trifluoromethanosulfonate, lithium perchlorate, and the like. The medium can comprise graphite, carbon black, or a siloxane.

In various embodiments, methods of making batteries are provided. A method can comprise making an electrode from the methods described above and combining the electrode with a transmission medium configured to transmit lithium ions into and out of the electrode. A transmission medium can comprise an electrolyte. The electrode can serve as either the anode or the cathode of the battery, or both.

In various embodiments, a method of charging a lithium ion battery is provided. The method can comprise applying a current to an electrode comprising core-shell structured nanoparticles. At least a portion of nanoparticles can comprise a lithium metal or lithium alloy core and a shell disposed over the core. The shell can comprise lithium nitride. The method can comprise allowing lithium ions to migrate through the shells. The method can comprise reincorporating the lithium ions into vacancies in the lithium metal or lithium alloy core crystallographic structures.

In various embodiments, a composition of nanoscale lithium alloy particles suitable for use in at least one electrochemical application is provided. The alloy particles can comprise alloy particles having a substantially uniform particle size and being configured so as to maintain a substantially body centered cubic crystal structure during insertion and removal of lithium from the alloy during an electrochemical process.

In various embodiments, structured nanoparticles suitable for use in at least one electrochemical application are provided. The nanoparticles can have a core-shell structure. The nanoparticles can comprise lithium metal or lithium alloy having a body centered cubic crystal structure. The nanoparticles can comprise a lithium metal or lithium alloy core and a shell disposed over the core, wherein the shell is configured to conduct lithium ions to and from the core. The shell can comprise lithium nitride. The shell can be insulating. The shell can have a thickness between above 2 and 5 nanometers. The core can comprise a crystal structure that is substantially body centered cubic during insertion and removal of lithium ions. The lithium alloy core can comprise a body centered cubic solid solution of lithium metal and one or more alloying metals or semi-metals selected from the group consisting of Ca, Na, Ba, Mg, Al, Sn, Si, Cu, Ag, Au, and Pd.

In various embodiments, electrodes are provided. An electrode can comprise a current collector configured to receive an electrical connection. The electrode can comprise a film disposed on the current collector. The film can comprise an ink comprising the compositions described above. The current collector can comprise a metal foil, such as a copper foil. The current collector can comprise nanoparticles. At least a portion of the nanoparticles can comprise a lithium metal or lithium alloy core and a shell disposed over the core, wherein the shell is configured to conduct lithium ions to and from the core. The shell can comprise lithium nitride. The shell can have a thickness between about 2 and 5 nm. The core can comprise a crystal structure that is substantially body centered cubic during insertion and removal of lithium ions. The core can comprise a body centered cubic solid solution of lithium metal and one or more alloying metals or semi-metals selected from the group consisting of Ca, Na, Ba, Mg, Al, Sn, Si, Cu, Ag, Au, and Pd. The current collector can comprise a binding agent. The binding agent can comprise polyvinylidene fluoride or poly tetrafluoroethylene. The current collector can comprise one or more additives configured to enhance stability or conductivity. One or more of the additives can comprise graphite, carbon black, or a siloxane.

In various embodiments, batteries are provided. A battery can comprise an electrode as described above and a transmission medium configured to transmit lithium ions into and out of the electrode. A transmission medium can comprise an electrolyte. The electrode can serve as either the anode or the cathode of the battery or both. The electrode can be an anode. A battery can comprise an anode and cathode and a transmission medium configured to transmit lithium ions between the anode and the cathode. At least one of the anode or cathode can comprise nanoparticles comprising a lithium metal or lithium alloy core and a shell disposed over the core, wherein the shell is configured to conduct lithium ions to and from the core. The shell can comprise lithium nitride. The core can comprise a body centered cubic solid solution of lithium metal and one or more alloying metals or semi-metals selected from the group consisting of Ca, Na, Ba, Mg, Al, Sn, Si, Cu, Ag, Au, and Pd.

For purposes of summarizing the embodiments and the advantages achieved over the prior art, certain items and advantages are described herein. Of course, it is to be understood that not necessarily all such items or advantages may be achieved in accordance with any particular embodiment. Thus, for example, those skilled in the art will recognize that the inventions may be embodied or carried out in a manner that achieves or optimizes one advantage or group of advantages as taught or suggested herein without necessarily achieving other advantages as may be taught or suggested herein.

### BRIEF DESCRIPTION OF THE DRAWINGS

A general architecture that implements the various features of the disclosed systems and methods will now be described with reference to the drawings. The drawings and the associated descriptions are provided to illustrate embodiments and not to limit the scope of the disclosure.

FIG. 1A is a flow diagram demonstrating an example method of preparing a nanoscale Li alloy composition.

FIG. 1B is a flow diagram demonstrating an example method of preparing an electrode comprising a nanoscale Li alloy composition.

FIG. 2 shows cyclic voltammograms for a Li metal working electrode and for a core-shell structured lithium nitride film on a Li metal working electrode.

### DETAILED DESCRIPTION

Due to its unfilled 2s electron orbital, lithium metal is highly reactive with the environment. This has imposed significant limitations on the use of pure lithium metal in lithium-ion batteries. Furthermore, the reactivity of lithium nanoparticles is greater than for lithium metal, due to the increased surface area available for reaction. Given this increased reactivity, lithium nanoparticles have not previously been seen as a viable active material in rechargeable batteries, despite potential advantages in specific capacity and kinetics relative to the traditional C₆Li anode.

In an effort to overcome the reactivity issue associated with lithium nanoparticles, lithium may be alloyed with one or more other elements. Lithium compositions comprising alloyed nanoscale particles for use in electrochemical applications are disclosed herein. The alloyed structure can advantageously impart stability to highly reactive Li nanoparticles in electrochemical processing environments. In some embodiments, the lithium compositions can be configured to maintain a substantially BCC crystalline structure during Li insertion and removal processes. Because there is little or no crystallographic stress involved in Li removal and incorporation, a BCC structure can lead to much longer cycle life during charge and discharge of Li from the compositions. Thus, alloyed lithium nanoparticles are a compromise between increased stability and decreased specific capacity relative to pure lithium metal, while maintaining a crystal structure that minimizes volume expansion, and thus improves cycling ability. Additional advantages of the compositions disclosed herein can further include faster kinetics of Li removal and insertion. Faster kinetics of Li movement in turn enables faster charging and discharging of the rechargeable Li battery described herein. These lithium compositions are suitable for use in applications such as electrodes, batteries, fuel cells, and capacitors, because of their stability in a variety of electrochemical systems.

Li metal exists at room temperature in the BCC structure. Various embodiments include the realization that a BCC crystal structure can be maintained in nanoscale Li alloy compositions, even after electrochemical removal of Li during anodic discharge in a battery, up to a certain composition limit. The battery discharge process removes Li ions from the composition, creating vacancies within the crystallographic structure. Li ions are reincorporated into these vacancies during battery recharge by topotactic insertion, such that no significant change occurs in the configuration of the host lattice. The insertion of Li involves only a change in the overall (and also the local) composition of the solid solution, rather than the formation of additional phases.

As used herein, the term “nano” refers to a particle with a maximum dimension between about 1 and 999 nanometers. Typically, the particles are generally spherical, and consequently this dimension can also be considered the “effective diameter” of a particle. However, other shapes are also observed. Preferably, the nanoparticles have a diameter of less than about 1 μm, less than about 100 nm, more preferably less than about 50 nm, even more preferably less than about 25 nm, and most preferably less than about 10 nm. In some embodiments, the standard deviation of the nanoparticle diameter distribution is less than about 4 nm, preferably less than about 2 nm. The use of the prefix “n” or “nano” before a material indicates that the material is nanoparticulate.

Lithium compositions are disclosed comprising nanoparticles having a Li metal or Li alloy core and a shell structure disposed over at least a portion of the core. Preferably, the shell structure encapsulates the Li metal or Li alloy core. The shell can be thin, for example, between approximately 2 and 5 nanometers thick. The shell can impart a passive nano-layer on the Li metal core surface, advantageously improving stability in subsequent process environments (e.g., anodes and electrode assemblies). These core-shell structured Li nanoparticles are formed prior to their incorporation into electrodes. In some embodiments, the nanoparticles have a Li metal core and a lithium nitride shell. The lithium nitride shell was found to be extremely stable, however, other shell materials which conduct lithium ions are suitable for use herein. Various embodiments include the realization that the lithium nitride nano-layer described with regard to the above embodiments can function as a fast ion conductor for lithium ions. Lithium nitride has the highest conductivity of any inorganic lithium salt, because it comprises two types of crystalline layers: one layer comprising the composition Li₂N⁻ (containing 6 coordinate lithium centers) and the other layer comprising lithium cations (Li⁺). The lithium nitride nano-layer can also serve as a solid-electrolyte interface (SEI) with an electrolyte used in a lithium battery. The resulting SEI is characterized by higher ionic conductivity than any of the SEIs formed in traditional lithium-ion batteries.

This shell can preferably comprise up to about 70% of the total weight of the nanoparticle, and depending on the particle size, the layer can have a thickness of from about 0.1 nm to greater than about 25 nm, preferably from about 0.1 to about 10 nm, and more preferably between about 2 and 5 nm. The amount of the shell of the nanoparticles can be adjusted based on the application. For example, the shell can comprise less than about 70%, less than about 60%, less than about 50%, less than about 40%, less than about 30%, less than about 10%, or less than about 5% by weight of the nanoparticle.

During the discharge process, a portion of the Li ions migrate to the cathode. In certain embodiments, a portion of the Li ions are released from the core-shell structures, creating vacancies in the crystallographic structure of the core. During the recharge process, Li ions are reincorporated into these vacancies. In certain embodiments, Li ions can be reinserted into the core structures by migrating across the thickness of the encapsulating shells, the shells being Li ion conducting.

Various embodiments include the realization that nanoparticles having a Li metal core can be used to make stable electrodes. By providing a shell structure over at least a portion of (and preferably encapsulating) the Li metal core, the resulting electrodes surprisingly avoid the problem of dendrite formation ordinarily observed in Li metal electrodes. The shell structures can advantageously impart stability to highly reactive Li metal nanoparticles in electrochemical processing environments while permitting fast ion conduction of Li ions in and out of the shell structures.

In certain embodiments, lithium compositions are disclosed comprising nanoparticles having a Li alloy core and a shell structure disposed over at least a portion of (and preferably encapsulating) the core. Preferably, the Li alloy core has a body centered cubic (BCC) crystal structure. However, while BCC-structured alloys present certain advantages, the Li alloy core can have another crystal structure, such as a non-homogenous crystal structure. Li atoms are alloyed in situ with one or more metal atoms to form a Li-metal alloy. The resulting alloy is formed into nanoparticles having a core-shell structure with a suitable process. Preferably, the process is selected to maintain a BCC structure in the core, such as a gas phase condensation process. The nanoparticles are suitable for use in electrochemical applications.

The above-described Li alloy compositions are distinguished from Li alloy compositions formed by electrochemical processes. In electrochemical processes, a cathode is a source of Li ions, and upon application of a current the Li ions are driven into the anode where they intercalate or alloy with one or -more metals. The nanoscale Li alloy compositions disclosed herein are formed prior to their incorporation into anodes, and are characterized by increased Li capacity, high Li diffusion kinetics, and/or increased durability. These compositions are useful in electrodes for catalytic or electrochemical applications, such as batteries, fuel cells, and capacitors.

The nanoscale Li alloy compositions disclosed herein have been found to present numerous advantages. For instance, the Li content within the alloy can be high, resulting in increased capacity. As another example, the Li content can be controlled during nanoparticle synthesis. Alloys made at the nanoscale were found to have a more uniform composition and more homogeneous crystallographic morphology than a lithium particle-host configuration, improving lithium diffusion kinetics. Further, binders and additives can be more uniformly coated on the particles, resulting in improved conductivity properties. In addition, the process and materials described herein can be conducive to mass electrode production for use in rechargeable lithium batteries. Another advantage is that the preservation of the alloy matrix during Li removal and reinsertion serves as an electronic conductor, enhancing electrode conductivity and minimizing use of other additional conductive agents (such as carbon or graphitic carbon) during electrode fabrication, thus increasing gravimetric energy capacity.

In various embodiments disclosed herein, Li alloys can be created that retain the inherent BCC structure of lithium. The Li alloys enable Li atoms to move in and out of the crystal lattice without resulting in structural strain in the lattice.

Several lithium alloys are suitable for use as nanoscale Li alloy compositions. Preferably, a composition comprises Li—M, wherein M is at least one other metal or semi-metal that is characterized by a BCC crystal structure similar to Li. Preferably, the at least one metal or semi-metal is capable of forming a solid solution with a BCC crystal structure at high lithium concentrations. For example, while pure Mg crystallizes in the hexagonal system, Mg—Li alloys are partly or completely crystallized in the cubic crystal system, having the character of the cubic structure of pure Li. The addition of Li to Mg in sufficient quantities changes the crystal structure of the alloy from hexagonal to cubic, beyond 8.5 wt % Li. Beyond this composition (8.5 to 100% Li), the alloy system is isomorphous as a single beta (β) phase alloy structure. If Li and M are characterized by similar BCC configurations, their incorporation in a nanoscale Li alloy composition can advantageously minimize crystallographic expansion during the charging process. Of course, the degree of similarity between the crystallographic structures of Li and M can vary among various embodiments depending upon the efficiency desired or tolerated.

M can advantageously comprise a material having a high electrochemical potential, such as Na, Ca, and Mg. Various embodiments include the realization that nanoscale Li alloy compositions having a BCC crystal structure can be formed with materials such as Al and Ba, as well as elements with lower electrochemical potential such as Sn, Si, Cu, Ag, Au, and Pd. These nanoscale Li alloy compositions, having an initial BCC structure during nano-alloy formation, have been shown to maintain their structural stability over repeated charge and discharge cycles. The observed stability stands in sharp contrast to the fracturing caused by phase changes typically observed in alloys, such as Sn and Si alloys, prepared using electrochemical processes discussed above.

### Composition Preparation Processes

The nanoparticles disclosed herein can be made from a number of manufacturing process. Examples of suitable processes for manufacturing nanometal particles are described in U.S. Pat. No. 7,282,167 to Carpenter issued on Oct. 16, 2007; and U.S. Patent Application Publication No. US 2008/0108005 A1, filed on Nov. 2, 2006, the entire contents of both of which are hereby expressly incorporated by reference. The '167 patent and the '005 publication describe processes for making nanometal particles more uniformly.

The manufacturing process preferably comprises gas phase condensation in a reactor, which can advantageously enhance the stability of the crystallographic structure. Gas phase condensation of a nanomaterial in effect anneals the condensed nano-material. Annealing is a heat treatment process that relieves crystallographic strain and/or homogenizes the composition or structure of an element or alloy. The resulting nanoparticles are characterized by decreased crystallographic stresses during formation and can remain with little or no crystallographic strain. The gas phase condensation process can advantageously improve the homogeneity of an alloy's crystal structure. Of course, while gas phase condensation offers certain advantages, other processes such as thermo-mechanical milling or solution pyrolysis can be employed in the embodiments.

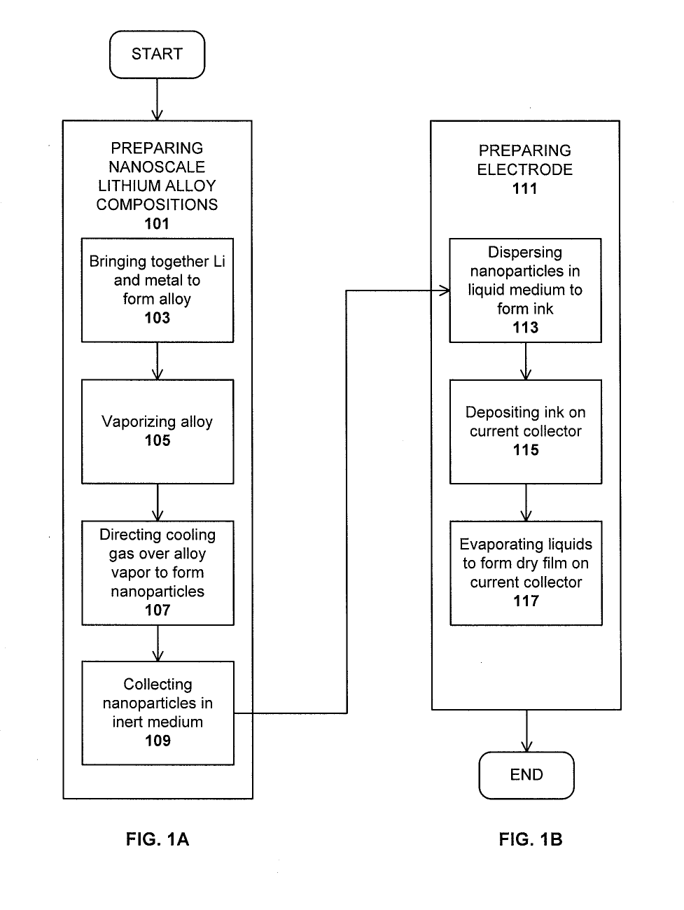

Turning now to FIG. 1A, Box 101 demonstrates an example method of preparing nanoscale Li alloy compositions. In at least one contemplated method of preparing nanoscale Li alloy compositions, the method comprises:
bringing together Li and one or more other metals or semi-metals to form an alloy, as shown in Box 103;
vaporizing the alloy to form an alloy vapor, as shown in Box 105; and
directing a cooling gas over the alloy vapor to form nano-metal particles having a substantially uniform nanoscale particle size, as shown in Box 107.

A similar process can be used for forming nanoscale Li metal compositions. The act of bringing together Li and one or more other metals or semi-metals to form an alloy can be omitted from such a process.

With reference to Box 103, an example of a suitable technique for bringing together Li and one or more other metals or semi-metals is melting. Preferably, the Li and other ingredient(s) are heated to a temperature at or above the melting point of the mixture. The ingredient(s) can optionally be mixed or agitated to promote uniform incorporation.

The cooling gas described in Box 107 first condenses the alloy vapor into alloy liquid nano-droplets and then into solid nano-particles. Preferably, the cooling gas is configured to rapidly solidify the alloy liquid nano-droplets into solid nano-particles. Due to the increased reactivity of high surface area of the Li alloy nanoparticles, preparation of nanoscale Li compositions preferably occurs in a substantially oxygen-free environment. Preferably, the cooling gas comprises an inert gas, such as argon or helium.

In some embodiments, the cooling gas can comprise a reactive gas suitable for forming a shell structure over a Li metal or alloy core. However, alternative techniques for forming the shell structure can be used. In certain embodiments, the cooling gas comprises a small amount of nitrogen gas. Examples of suitable concentrations for the nitrogen gas are concentrations less than about 10% or less than about 5%. An example of a suitable flow rate for the nitrogen gas is about 1 SLPM or less. The inclusion of nitrogen case in the cooling gas can create a thin lithium nitride shell on the condensed solid nano-alloy particles, as described above. In certain embodiments, the pressure and flow rate of the nitrogen gas for forming the lithium nitride shell can be adjusted to impart the required shell thickness to maintain and optimize the properties of chemical stability and lithium ion permeability.

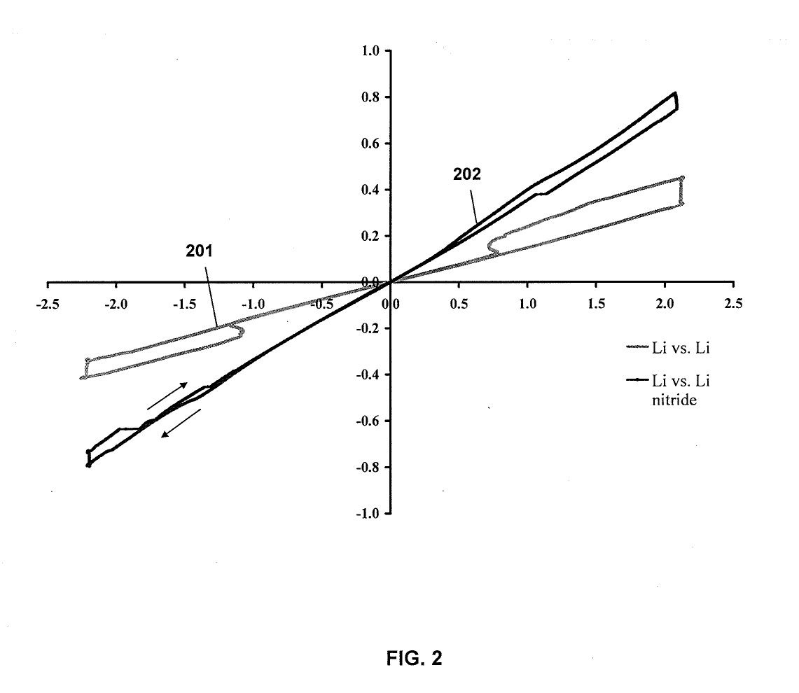

The lithium nitride shell encapsulating the lithium nanoparticles is permeable to lithium ions. Referring to the cyclic voltammogram in FIG. 2, the cycling behavior of a Li metal working electrode 201 is compared to core-shell structured lithium nitride film on lithium metal working electrode 202 after 10 cycles. In both cases, the counter electrode used is lithium metal. In the negative voltage direction, Li ions migrate from the counter electrode to the working electrode, and in the positive direction Li ions are migrate from the working electrode to the counter electrode. In both working electrode 201 and working electrode 202, there is a high degree of reaction reversibility, indicating that the lithium nitride film is capable of conducting Li ions without significant constraints on Li ion diffusion.

In at least one embodiment, the alloy vapor comprises Li and Mg. The alloy vapor is treated with a cooling gas comprising nitrogen gas to form condensed solid nano-Li—Mg alloy particles encapsulated in a nitride shell. It was found that Li—Mg nano-alloys can advantageously enhance the above-described nitride shell around the core of the Li—Mg nano-alloy, because both Li and Mg form nitrides which are mutually compatible and can co-exist.

Various embodiments include the realization that due to the high reactivity of nanoscale Li particles (metal and alloys), the particles can be stabilized in an inert medium, such as a non-reactive solvent or dispersion medium. Accordingly, as shown in Box 109, as the nanoparticles are formed in the cooling gas stream, they optionally can be collected in an inert medium. The inert medium can also be configured to maintain small particle size and/or long term stability. In certain embodiments, the nanoparticles are collected in a non-reactive container in the presence of an inert gas medium, such as helium or argon. The non-reactive container can optionally contain an inert liquid medium configured to stabilize the nanoparticles in a protective layer and prevent oxidation. Preferably, the inert liquid medium comprises solvents and/or binders used to make electrodes in a Li ion battery. Most preferably, the inert liquid medium is one or more carbonates, glymes, or ionic liquids. However, other liquid media that do not substantially react with the nanoparticles are also suitable for use.

### Electrode Preparation Processes

In certain embodiments, the above-described lithium compositions can be incorporated in an electrode. Preferably, the electrode is an anode. However, the lithium compositions can be incorporated into cathodes. These electrodes are suitable for use in a number of electrochemical applications, such as rechargeable Li batteries. For instance, a battery can be provided comprising a positive electrode and a negative electrode a transmission medium configured to transmit lithium ions between the positive electrode and the negative electrode, wherein at least one of the positive electrode or the negative electrode comprises nanoscale alloy particles having a body centered cubic solid solution of lithium and a metal or semi-metallic alloying material.

Methods of incorporating nano-metal particles into an electrode are described by way of example in U.S. patent application Ser. No. 11/868,152, filed on Oct. 5, 2007; U.S. patent application Ser. No. 12/114,718, filed on May 2, 2008, which claims priority to U.S. Provisional Patent Application Ser. No. 60/915,619, filed on May 2, 2007; U.S. patent application Ser. No. 12/053,484, filed on Mar. 21, 2008, which claims priority to U.S. Provisional Patent Application Ser. No. 60/896,722, filed on Mar. 23, 2007; U.S. patent application Ser. No. 11/781,909, filed on Jul. 23, 2007, which is a continuation-in-part of and claims priority to U.S. patent application Ser. No. 11/394,456, filed on Mar. 31, 2005, and published on Oct. 4, 2007, as U.S. Patent Application Publication No. US 2007/0227300 A1; and U.S. patent application Ser. No. 11/482,290, filed on Jul. 7, 2006, and published on Nov. 13, 2008, as Patent Application Publication No. US 2008/0280190 A1, which is a continuation-in-part of and claims priority to U.S. patent application Ser. No. 11/254,629, filed on Oct. 20, 2005, and published on Apr. 26, 2007, as U.S. Patent Application Publication No. US 2007/0092784 A1, the entire contents of all of which are expressly incorporated herein by reference.

Now referring to FIG. 1B, Box 111 demonstrates that in at least one contemplated method of preparing an electrode, the method comprises:
dispersing the nanoparticles in an inert medium to form a liquid ink, as shown in Box 113;
depositing a layer of the ink onto a current collector, as shown in Box 115; and
evaporating liquids from the ink to form a dry film, as shown in Box 117.

The ink is so-called because the ink can resemble a black, substantially opaque liquid. The act of dispersing the nanoparticle in an inert medium to form a liquid ink, shown in Box 113, can be optionally performed during the process of forming and collecting the nanoparticles in the production reactor as described above or subsequently during electrode fabrication. A number of inert media, such as compatible solvents or dispersions, are suitable for use in the disclosed embodiments. Examples of inert media include one or more carbonates, glymes, or ionic liquids.

In certain embodiments, a binder agent is added to the liquid ink. In various embodiments, the binder agent is less than 50 wt %, more preferably less than 40 wt %, more preferably less than 30 wt %, and most preferably less than 20 wt % of the total ink composition. The binder agent can advantageously facilitate the formation of a cohesive film and/or minimize nanoparticle migration away from the current collector, resulting in a loss of electrical contact. Preferably, a fluorinated binding agent such as polyvinylidene fluoride (PVDF, Kynar®) or poly tetrafluoroethylene (PTFE, Teflon®) is dissolved in a polar aprotic solvent. Examples of suitable polar aprotic solvents include, for example, N-methyl pyrrolidone, dimethylsulfoxide, hexamethyl phosphoramide, and diethyl acetamide. In preferred embodiments, the binder agent does not significantly increase the resistance of the formed electrode.

The embodiments disclosed herein offer additional advantages over CVD deposition processes (described above) because additives which enhance conductivity and/or increase stability can optionally be added to the liquid ink. Suitable additives can comprise powdered carbon- or silica-based materials, including but not limited to graphite, carbon black, or a siloxane. CVD is a stand-alone process and does not allow for further tailoring of the active electrode layer, for example, addition of electrically conductive additives such as graphite or a binding material such as poly vinylidene fluoride. Lithium and lithium nanoparticles are highly unstable and reactive with many solvents. Solvents in the ink making process must be selected to ensure that the nanoparticles do not react or decompose during the electrode making process. An alternative strategy described in the embodiments is to modify the reactivity of the nanoparticles using a core-shell morphology.

As described above with reference on Box 115, a layer of ink can be deposited on a current collector. In at least one embodiment, the ink is deposited as a thin layer, preferably 0.5 mil to 5 mils thick, onto a metal foil current collector, for example copper foil. The thin layer can be deposited by one of a number of techniques, including but not limited to tape casting, draw-down, spraying, and screen-printing.

The ink layer deposition process is preferably controlled such that the dry film has a substantially uniform thickness. In certain embodiments, copper foil with the dry film can be cut to a desired shape, to fit the battery shape to use as an electrode in, for example, a rechargeable lithium battery.

### EXAMPLE 1

### PREPARATION OF A Li—Mg ELECTRODE

A nanoscale Li alloy composition comprising 100 mg of Li—Mg nanometal powder was added to 50 mg of 1 M lithium hexafluorophosphate in 1:1 ethylene carbonate/diethyl carbonate and 3 mg of Timcal® conductive graphite in a non-reactive container. The container was sealed and blended on a vortex mixer for 5 minutes.

The resulting ink was applied to a copper current collector and tested in a 2032CR coin cell against a Li metal counter electrode. The open circuit potential of the cell was 2.7 mV vs. Li/Li⁺.

Although this invention has been described in terms of certain preferred embodiments, other embodiments that are apparent to those of ordinary skill in the art, including embodiments which do not provide all of the benefits and features set forth herein, are also within the scope of this invention. Accordingly, the scope of the present invention is defined only by reference to the appended claims.

What is claimed is:

1. A method of preparing nanoscale body-centered cubic lithium alloy for use in an electrochemical application, the method comprising bringing together lithium and a metallic or semi-metallic alloying material to form an alloy, vaporizing the alloy to form an alloy vapor, and directing a cooling gas over the alloy vapor to form nanoscale alloy particles having a substantially uniform particle size, the alloy nanoscale particles being configured so as to maintain a substantially body centered cubic crystal structure during insertion and removal of lithium from the alloy during an electrochemical process.

2. The method of claim 1 wherein the nanoscale particles comprise a core-shell structure comprising a lithium metal or lithium alloy core; and an insulating shell configured to conduct lithium ions to and from the core.

3. The method of claim 2 wherein the shell comprises lithium nitride.

4. A method of preparing an electrode using the nanoscale particles generated from the method of claim 1, the method comprising dispersing the nanoscale alloy particles in a medium to form a liquid ink; depositing a layer of the ink onto a current collector; and evaporating liquids from the ink to form a dry film.

5. The method of claim 4, wherein the medium comprises an inert liquid comprising one or more of carbonates, glymes, or ionic liquids.

6. The method of claim 4, wherein the medium comprises a binding agent.

7. The method of claim 6, wherein the binding agent comprises polyvinylidene fluoride or poly tetrafluoroethylene.

8. The method of claim 4, wherein the medium comprises a polar solvent.

9. The method of claim 8, wherein the polar solvent comprises diethyl acetamide, N-methyl pyrrolidone, or dimethylsulfoxide, hexamethyl phosphoramide.

10. The method of claim 4, wherein the medium comprises one or more stability-enhancing additives or conductivity-enhancing additives.

11. The method of claim 10 wherein the medium comprises one or more lithium salts.

12. The method of claim 11, wherein the medium comprises one or more of lithium hexafluorophosphate, lithium trifluoromethanosulfonate, or lithium perchlorate.

13. The method of claim 10, wherein the medium comprises graphite, carbon black, or a siloxane.

14. The method of claim 4, wherein depositing comprises tape casting, draw-down, spraying, or screen-printing.

15. The method of claim 1, wherein the cooling gas comprises nitrogen gas.

16. The method of claim 1 further comprising collecting the nanoparticles in a medium that is inert to the nanoscale alloy particles.

17. The method of claim 16, wherein the medium comprises a gas medium comprising argon or helium.

18. The method of claim 16, wherein the medium comprises a liquid medium comprising one or more of carbonates, glymes, or ionic liquids.

19. A method of making a battery comprising making an electrode from the method of claim 4 and combining it with a transmission medium configured to transmit lithium ions, the electrode serving as either the anode or the cathode of the battery.

20. A composition of nanoscale lithium alloy particles suitable for use in at least one electrochemical application, the alloy particles comprising alloy particles having a substantially uniform particle size and being configured so as to maintain a substantially body centered cubic crystal structure during insertion and removal of lithium from the alloy during an electrochemical process.

21. The composition of claim 20 wherein the nanoscale particles comprise a core-shell structure comprising a lithium metal or lithium alloy core and an insulating shell configured to conduct lithium ions to and from the core.

22. The composition of claim 21 wherein the shell comprises lithium nitride.

23. The composition of claim 20 wherein the metallic or semi-metallic alloying material comprises one or more metals or semi-metals selected from the group consisting of Ca, Na, Ba, Mg, Al, Sn, Si, Cu, Ag, Au, and Pd.

24. The composition of claim 22 wherein the lithium nitride shell has a thickness between about 2 and 5 nanometers.

25. An electrode comprising a current collector configured to receive an electrical connection and a film disposed on the current collector, the film comprising an ink comprising the composition of claim 20.

26. The electrode of claim 25, wherein the current collector comprises a metal foil.

27. The electrode of claim 26, wherein the current collector comprises copper foil.

28. A battery comprising an electrode of claim 25 and a transmission medium configured to transmit lithium ions, the electrode serving as either the anode or the cathode of the battery.

29. The electrode of claim 28 wherein the electrode is an anode.

30. Core-shell structured nanoparticles suitable for use in at least one electrochemical application, the nanoparticles comprising a lithium metal or lithium alloy core; and a shell disposed over the core, wherein the shell is configured to conduct lithium ions to and from the core.

31. The nanoparticles of claim 30, wherein the shell comprises lithium nitride.

32. The nanoparticles of claim 30, wherein the shell has a thickness between about 2 and 5 nanometers.

33. The nanoparticles of claim 30, wherein the core comprises a crystal structure that is substantially body centered cubic during insertion and removal of lithium ions.

34. An electrode comprising a current collector configured to receive an electrical connection, the current collector comprising nanoparticles, wherein at least a portion of the nanoparticles comprise a lithium metal or lithium alloy core and a shell disposed over the core, wherein the shell is configured to conduct lithium ions to and from the core.

35. A battery comprising an anode and cathode, wherein at least one of the anode or cathode comprises nanoparticles comprising a lithium metal or lithium alloy core and a shell disposed over the core, wherein the shell is configured to conduct lithium ions to and from the core; and a transmission medium configured to transmit lithium ions between the anode and the cathode.

36. A method of charging a lithium ion battery, the method comprising applying a current to an electrode comprising core-shell structured nanoparticles, wherein at least a portion of nanoparticles comprise a lithium metal or lithium alloy core and a shell comprising lithium nitride disposed over the core; allowing lithium ions to migrate through the shells; and reincorporating the lithium ions into vacancies in the lithium metal or lithium alloy core crystallographic structures.
